(19) United States
(12) Patent Application Publication
(10) Pub. No.: US 2009/0298483 A1
(43) Pub. Date: Dec. 3, 2009

(54) METHOD AND APPARATUS FOR SELECTING ADVERTISEMENTS AND DETERMINING CONSTRAINTS FOR PRESENTING THE ADVERTISEMENTS ON MOBILE COMMUNICATION DEVICES

(75) Inventors: Ben BRATU, Basingstoke (GB); Simon Waddington, Basingstoke (GB)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 12/131,309

(22) Filed: Jun. 2, 2008

(51) Int. Cl. G06Q 30/00; H04Q 7/22

(52) U.S. Cl. 455/414.2; 705/14.67

(57) ABSTRACT

A method and apparatus that selects advertisements and determines constraints for presenting the advertisements to a user on a mobile communication device is disclosed. The method may include receiving context history information for a user from one or more retail companies, constructing a profile for the user using the received context history information, storing the user's profile in a user profile database, receiving advertisements from the one or more retail company, storing the received advertisements in an advertisement database, selecting stored advertisements to be sent to the user based on the user's profile, determining constraints on the selected advertisements based on at least one of location and time, and sending the selected advertisements and the determined constraints to the user's mobile communication device for presentation to the user at a particular location and a particular time based on the determined constraints.

### BACKGROUND OF THE DISCLOSURE

1. Field of the Disclosure

The disclosure relates to advertisements sent to and presented on mobile communication devices.

2. Introduction

Recent studies state that if advertisements were sent to mobile communication devices, users would generally prefer to receive advertisements that are targeted to their individual interests. There are a rapidly increasing number of mobile context-aware services and systems in the marketplace. Conventional work on context-awareness has been largely concentrated on location information in order to offer to the user's mobile-communication device items such as travel, shopping, entertainment and event information.

Following this trend, there are also a couple of different studies on mobile advertising based exclusively or in high proportion on location information. The main characteristic of those systems is the fact that all of them are based on synchronous communication between the mobile communication device and the content server.

However, there two main problems with this approach. The first problem is that there is generally a time lag between the moment the user arrives in a targeted location and when the advertisement is actually displayed on his or her device. This delay depends greatly on the network latency and on its capacity to cope with peak demands. In the case of significant delays, some displayed advertisements will not correspond to the current user location.

The second problem is that, although the communication infrastructure may be in place, the current protocols do not support real-time communication between the server and the user. Another characteristic of the conventional systems is the fact that they facilitate blind advertising by exploiting only the concept of nearby users without taking in consideration any personal information. For instance any person passing by a coffee shop may receive an advertisement for white coffee without any consideration of the person's coffee time or coffee type preferences

### SUMMARY OF THE DISCLOSURE

A method and apparatus that selects advertisements and determines constraints for presenting the advertisements to a user on a mobile communication device is disclosed. The method may include receiving context history information for a user from one or more retail companies, constructing a profile for the user using the received context history information, storing the user's profile in a user profile database, receiving advertisements from the one or more retail company, storing the received advertisements in an advertisement database, selecting stored advertisements to be sent to the user based on the user's profile, determining constraints on the selected advertisements based on at least one of location and time, and sending the selected advertisements and the determined constraints to the user's mobile communication device for presentation to the user at a particular location and a particular time based on the determined constraints.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates a diagram of an exemplary personal advertisement environment in accordance with a possible embodiment of the disclosure;

FIG. 2 illustrates a block diagram of an exemplary personal advertising server in accordance with a possible embodiment of the disclosure;

FIG. 3 illustrates an exemplary block diagram of a personal advertising unit in accordance with a possible embodiment of the disclosure; and

FIG. 4 is an exemplary flowchart illustrating a possible personalized advertising process in accordance with one possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure may comprise a variety of embodiments, such as a method and apparatus and other embodiments that relate to the basic concepts of the disclosure. This disclosure may concern offering advertisements to an intended customer and at the intended moment. The disclosure may offer a method of linking distributed profiles in a manner that helps the retail companies to offer advertisements not only based on the user's past history, but on the user's present context, as well. Advertisements presented using this method may be linked with the user's dynamic context, and therefore more relevant to his or her interests.

The user's explicit preferences, implicit preferences, behavior patterns, and contextual information may be used in order to display on his or her mobile communication device, a specific advertisement at a specific time. Based on user monitoring feature, the system can identify and measure the impact of the advertisement on a user. Thus, the process may be capable of determining the rate of customers' satisfaction and to offer this information to the retail companies.

In this manner, three problems may be addressed: 1) how to minimize the influence of the network over the advertising process; 2) how to avoid real-time communications between mobile device and server but still be capable of making the link between the advertisement content and the user's current context; and 3) how to use all the profile information different retail companies have collected on the same customer.

This disclosure may provide a process to link distributed and distinct profile information handled by different parties and based on those links, to offer personalized advertisements to a final customer. The process may be divided in three main parts:

1) One or more retail company may have information on the user and his or her purchasing profile based on which the retail company can construct customer personalized advertisements.

2) A personal advertising server may have information that permits it to determine patterns in the user behavior and thus to predict future actions. Based on this information, the personal advertising server may add contextual constraints on when the advertisement has to be displayed. The advertisements along with the constraints may then be sent to the user's mobile communication device; and

3) The user's mobile communication device may have information on the user's current context. By using contextual monitoring techniques, the user's mobile communication device may pre-filter and select to display those advertisements for which the user's current context satisfies all the constraints added by a particular retail company and by the personal advertising server.

Finally, in this process, advertisements may not just be sent to the best-suited customer for random viewing, but also they may be directed to be displayed at an appropriate moment. By taking in account not only the personal profile a retail company can build, but also the location, the time frame, and the context, the personal advertising environment of this disclosure may present the advertisement with the biggest impact to a targeted customer. In addition, unlike conventional systems which must use costly continuous real-time communication between the user mobile device and the server, the process of this disclosure may send the right advertisements at the right time without continuously occupying the communication link.

A retail company may have different information about the customers' last purchases. As such, the retail company may propose personalized advertisement for one or more of them. For example, suppose that a user has a loyalty card at a coffee shop and uses it most of the time when going there. Based on his or her purchasing history and using a simple statistical mechanism, for example, the company can determine the user habits (e.g., most of the times Monday to Friday around 8:30 the customer X is buying a white coffee at a coffee shop on Olentangy River Road). Using this profile, the company can choose to send to that particular user an advertisement with a white coffee reduction coupon, for example, on a day between Monday-to-Friday at 8:30 am. But the retail company may have no information to tell them that user is near the shop or on his way to the shop at that time, or other constraints that prevent him or her not to go the coffee shop with regularity at the same hour. However, the personal advertising server may assist the retail companies in this manner, as set forth below.

The personal advertising server may be responsible for:
1) Interaction with retail companies and mobile communication devices.
2) Constructing the implicit user profile using the context history information. By discretizing the values of the user context variables such as location, activity, schedule, physiology or the ambient context, a learning mechanism may construct a statistical model for the user context-dependent preferences. This type of mechanism can infer complex patterns in the user's behavior (e.g., Monday-to-Friday user X leaves home and goes to a particular coffee shop between 8:30 and 8:45 am if he or she has no meeting scheduled at 9 am and between 8 and 8:10 am if he or she has a meeting scheduled at 9 am). There may be different machine learning processes that can be used to learn and construct the user context dependent profiles, such as Bayesian Statistic models, tree models, rules based models, fuzzy rules models, etc.
3) Constructing the contextual constraints for displaying an advertisement to a targeted user. Depending on the number of the contextual variables that can be monitored by the targeted device (i.e., κ), the constraints may be seen as geometric boundaries of a κ-dimension space in which the advertisement should be displayed. Combining the information from the user profile constructed by the server and the ones coming from the retail company, the contextual boundaries for a preferred activity may be fully determined (e.g., if it is between 8 and 8:45 am and the user is near the coffee shop, then send him or her the white coffee advertisement).

The user's mobile communication device may be responsible for:
1) Context monitoring, whereby some of the handsets are capable of determining the location and other context information like time, usability, temperature, luminosity, background noise, other nearby devices, etc., for example.
2) Selecting the appropriate advertisement given the immediate context information. An independent thread process may monitor the immediate context information and each time the context may be suitable for one of the advertisements stored on the device, then that advertisement may be displayed on the screen to the user.

Giving the fact that both personal advertising server and the retail company have information about the user, each may construct a partial profile of a user. The retail company may have better information on the user preferences for types of products and the personal advertising server may have better information on when the user prefers to buy certain products. In this case, the advertising process may be initiated either by the retail company or by the personal advertising server by pushing or pulling the advertisements from the retail company.

For a retail company that may push advertisements to a targeted existing customer, the retail company may have a profile of his or her habits. Based on that profile, the company may identify the appropriate advertisement and it may specify different constraints that need to be satisfied in order to send the advertisement to the customer. The advertisement, the constraints, and the targeted customer identification may then be sent to the personal advertisement server.

The personal advertisement server may receive the advertisement and the associated constraints. Based on its own representation of the targeted user profile, the server may construct the context constraints that need to be satisfied in order to display the advertisement. The advertisement and the context constraints may then be sent to the user's mobile communication device. The mobile communication device may have the capability to monitor the appropriate context (e.g., time, location, usability, etc.) and when those constraints are satisfied, the advertisement may be displayed.

If the personal advertisement server pulls advertisements from the retail company, based on a monitoring and learning process, the operator may have the possibility to learn and to predict the user behaviour. In this instance, the operator may have the capability to identify a future context (e.g., location) for the targeted customer. Based on this prediction, the operator may ask the retail company for a personalized advertisement given the user identification and a general description of the context.

In both cases, the user may have to be aware of the process and of the information the different parties are exchanging between them. Privacy issues may be solved if the user is part of the process and he or she is the one that decides the types the data each of the parties may use. For example, when the user is signing up for the personal advertisement service, he or she may be asked permission for the operator to use monitored context information (e.g. location) for proposing better advertisements, as well as which companies the user will permit to be provided this information.

In the case of the retail companies, each time the customer is signing up for the loyalty programs, he or she may permit the company to send him or her advertisements and also admits that the data collected by the company is the property of that company. In some cases, the customer may even specify his or her address and phone number.

Another privacy issue that may raise a problem for the user in conventional systems is the identification each of the parties use for the same customer. However, in the disclosed process, it may not be necessary to identify the user by his or her full name as the user identification may be only his or her phone number, for example.

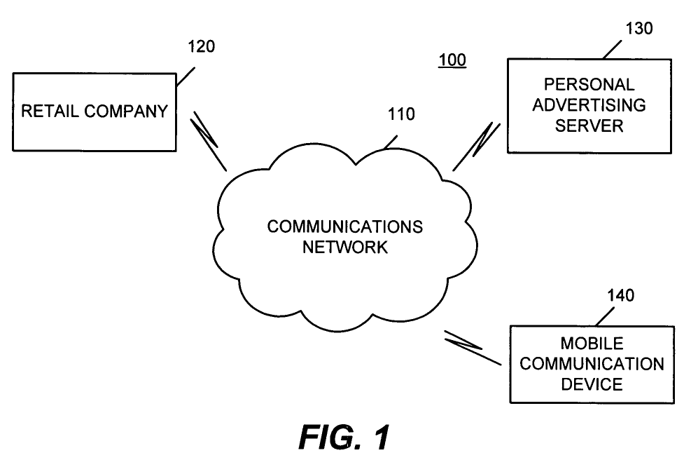

FIG. 1 illustrates a diagram of an exemplary personal advertisement environment 100 in accordance with a possible embodiment of the disclosure. In particular, although only one of each are shown for ease of discussion, the personal advertisement environment 100 may include a plurality of mobile communication devices 140, one or more personal advertisement server 130, and one or more retail company 120, connected through communications network 110.

Communications network 110 may represent any possible communications network that may handle telephonic communications, including wireless telephone networks, hardwired telephone networks, wireless local area networks (WLAN), the Internet, an intranet, etc., for example.

The one or more mobile communication device 140 may represent any device with a battery and a charger, including a portable MP3 player, satellite radio receiver, AM/FM radio receiver, satellite television, portable music player, portable computer, wireless radio, wireless telephone, portable digital video recorder, cellular telephone, mobile telephone, personal digital assistant (PDA), or combinations of the above, for example. Although only one mobile communication device 140 is shown this is merely illustrative. There may be any number of mobile communication devices 140 in the personal advertisement environment 100.

The one or more personal advertisement server 130 may represent a server, a computer, a personal computer, a portable computer, or a personal digital assistant, for example. The one or more retail company 120 may represent a server, a computer, a personal computer, a portable computer, or a personal digital assistant at the retail company 120 that may process information concerning their customers, products, services, etc., for example. Such customer information may result in the generation of advertisements, coupons, etc. that may be sent (pushed) by the retail company 120 to the personal advertising server 130 for eventual delivery to a customer's (user's) mobile communication device 140. Alternatively, the personal advertising server 130 may request (pull) advertisements for a customer from the retail company 120 for eventual presentation on the user's mobile communication device 140.

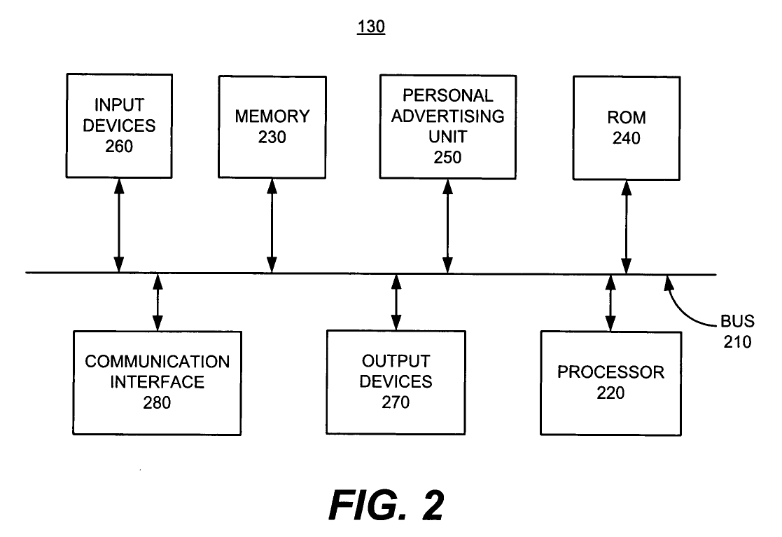

FIG. 2 illustrates a block diagram of an exemplary personal advertising server 130 in accordance with a possible embodiment of the disclosure. The personal advertising server 130 may include may include bus 210, processor 220, memory 230, read only memory (ROM) 240, personal advertising unit 250, input devices 260, output devices 270, and communication interface 280. Bus 210 may permit communication among the components of the personal advertising server 130.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Communication interface 280 may include any mechanism that facilitates communication via a network. For example, communication interface 280 may include a modem. Alternatively, communication interface 280 may include other mechanisms for assisting in communications with other devices and/or systems.

ROM 240 may include a conventional ROM device or another type of static storage device that stores static information and instructions for processor 220. A storage device may augment the ROM and may include any type of storage media, such as, for example, magnetic or optical recording media and its corresponding drive.

Input devices 260 may include one or more conventional mechanisms that permit a user to input information to the personal advertising server 130, such as a keyboard, a mouse, a pen, a voice recognition device, touchpad, buttons, etc. Output devices 270 may include one or more conventional mechanisms that output information to the user, including a display, a printer, a copier, a scanner, a multi-function device, one or more speakers, or a medium, such as a memory, or a magnetic or optical disk and a corresponding disk drive.

The personal advertising server 130 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 280.

The personal advertising server 130 illustrated in FIGS. 1 and 2 and the related discussion are intended to provide a brief, general description of a suitable communication and processing environment in which the invention may be implemented. Although not required, the invention will be described, at least in part, in the general context of computer-executable instructions, such as program modules, being executed by the personal advertising server 130, such as a communication server, communications switch, communications router, or general purpose computer, for example.

Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations, including personal computers, hand-held devices, multi-processor systems, microprocessor-based or programmable consumer electronics, and the like.

Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

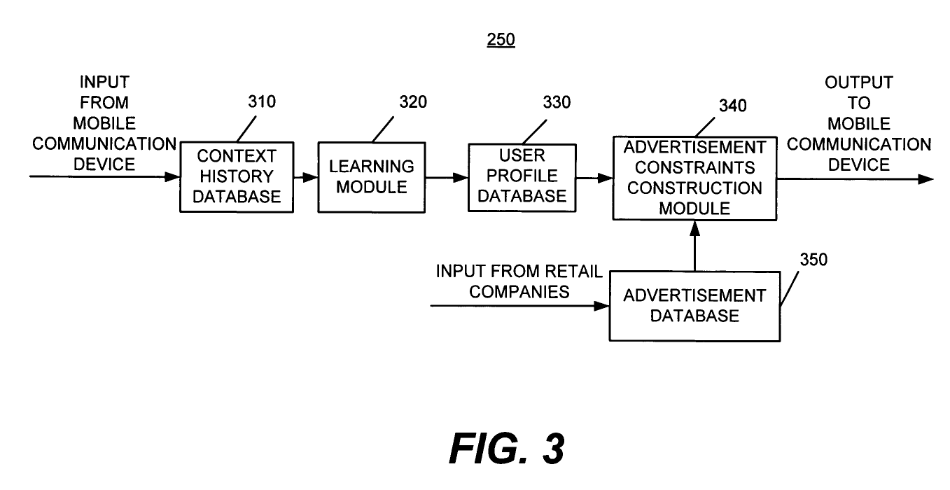

FIG. 3 illustrates an exemplary block diagram of a personal advertising unit 250 in accordance with a possible embodiment of the disclosure. The personal advertising unit 250 may include a context history database 310, a learning module 320, a user profile database 330, an advertisement constraints construction module 340, and an advertisement database 350. The context history database 310 may receive input from the user's mobile communication device 140 concerning the user's current context information. The user's current context information may include information such as location, time, usability, temperature, luminosity, background noise, activity, schedule, physiology, ambient context or other nearby devices, for example. The context history database 310 may also receive information concerning users from one or more retail company 120. User (or customer) information may include a user's purchase habits, shopping habits, address, or demographics information, for example.

The context history information may be received by a learning module 320 to create a user profile, for example. By utilizing the values of the user's current context information, such as location, activity, schedule, physiology or the ambient context, the learning module 320 may construct a statistical model for the user context-dependent preferences.

In this manner, the learning module 320 may infer complex patterns in the user's behavior. For example, the learning module 320 may recognize that Monday-to-Friday, a user Matthew, for example, leaves home and goes to a particular coffee shop between 8:30 and 8:45 am if he has no meeting scheduled at 9 am and between 8 and 8:10 am if he has a meeting scheduled at 9 am. The learning module 320 may use different machine learning processes to learn and construct the user context dependent profiles, such as Bayesian Statistic models, tree models, rules based models, fuzzy rules models, etc. The user profiles may then be stored in the user profile database 330.

The advertisement constraints construction module 340 may receive the user profiles from the user profile database 330 and construct the contextual constraints for displaying an advertisement to a targeted user. Depending on the number of the contextual variables that can be monitored be the targeted device, the constraints may be seen as geometric boundaries of a multi-dimensional space in which the advertisement should be displayed.

The advertisement constraints construction module 340 may receive advertisements from the advertisement database 350, which may have received the advertisements from one or more retail company 120, or other entity, for example. These advertisements may be based on at least one of a user's purchase habits, a user's shopping habits, a user's address, a user's demographics, etc., for example. The received advertisements may be stored in the advertisement database 350, for example.

Combining the information from the user profile constructed by the learning module 320 and the advertisements and information received from the retail company 120, the contextual boundaries for a preferred activity may be fully determined. For example, if it is between 8 and 8:45 am and a user Megan, for example, is near a particular doughnut shop, an advertisement may be retrieved from the advertisement database 350 and may be sent with the constraint to her mobile communication device 140 that instructs the device to display a chocolate muffin coupon based on the constraint.

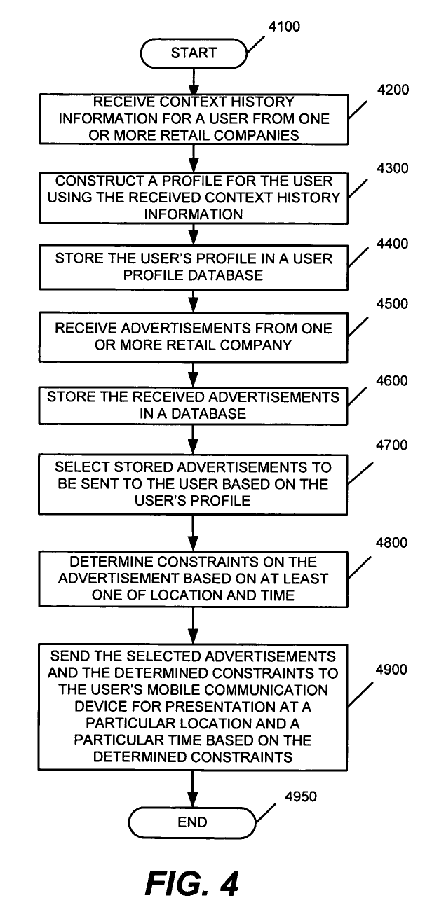

For illustrative purposes, the operation of the personal advertising server 130, the personal advertising unit 250, and the personalized advertising process are described in FIG. 4 in relation to the diagrams shown in FIGS. 1-3.

FIG. 4 is an exemplary flowchart illustrating a possible personalized advertising process in accordance with one possible embodiment of the disclosure. The process begins at step 4100 and continues to step 4200 where the personal advertising unit 250 may receive context history information for a user from one or more retail companies 120.

At step 4300, the personal advertising unit 250 may construct a profile for the user using the received context history information. At step 4400, the personal advertising unit 250 may store the user's profile in the user profile database 330. The user profile database 330 may be stored in any memory location, including memory 230, for example.

At step 4500, the personal advertising unit 250 may receive advertisements from the one or more retail company. As discussed above, the advertisements may be either pushed to the personal advertising unit 250 by the retail company 120 or pulled from the retail company 120 by the personal advertising unit 250. At step 4600, the personal advertising unit 250 may store the received advertisements in the advertisement database 350. The advertisement database 350 may be stored in any memory location including the memory 230, for example. At step 4700, the personal advertising unit 250 may select stored advertisements to be sent to the user based on the user's profile.

At step 4800, the personal advertising unit 250 may determine constraints on the selected advertisements based on location, time, etc., for example. At step 4900, the personal advertising unit 250 may send the selected advertisements and the determined constraints to the user's mobile communication device 140 for presentation to the user at a particular location and a particular time based on the determined constraints. Presentation of advertisements to the user on the user's mobile communication device 140 may be dependent on the user's schedule, for example. In addition, communications between the personal advertising server 130 and the mobile communication device 140 may be conducted on an intermittent basis. For example, the personal advertising server 130 may communicate with a mobile communication device 140 only once-a-day, once-a-week, or only when determined necessary by either the personal advertising server 130 or the mobile communication devices 140, for example. The process may then go to step 4950 and end.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the components of the disclosure each processing the content in various possible ways. It does not necessarily need to be one system used by all end users. Accordingly, the appended claims and their legal equivalents should only define the disclosure, rather than any specific examples given.

We claim:

1. A method for selecting advertisements and determining constraints for presenting the advertisements to a user on a mobile communication device, comprising:
receiving context history information for a user from one or more retail companies;
constructing a profile for the user using the received context history information;
storing the user's profile in a user profile database;
receiving advertisements from the one or more retail company;
storing the received advertisements in an advertisement database;
selecting stored advertisements to be sent to the user based on the user's profile;
determining constraints on the selected advertisements based on at least one of location and time; and
sending the selected advertisements and the determined constraints to the user's mobile communication device for presentation to the user at a particular location and a particular time based on the determined constraints.

2. The method of claim 1, wherein communications with mobile communication devices are conducted on an intermittent basis.

3. The method of claim 1, wherein presentation of advertisements to the user on the user's mobile communication device is dependent on the user's schedule.

4. The method of claim 1, wherein the advertisements are one of pushed and pulled from the one or more retail companies.

5. The method of claim 1, further comprising:
receiving current context information from the user's mobile communication device.

6. The method of claim 5, wherein the user's current context information includes at least one of location, time, usability, temperature, luminosity, background noise, activity, schedule, physiology, ambient context, and other nearby devices.

7. The method of claim 1, wherein advertisements are received from the retail companies based on at least one of a user's purchase habits, a user's shopping habits, a user's address, and a user's demographics.

8. The method of claim 1, further comprising:
receiving the user's identification information, geographic position information, and time information relating to the user's geographic position from the user's mobile communication device;
mapping the received geographic position information to addresses of one or more retail companies; and
storing the mapped addresses of the one or more retail companies and the related time information in the user's profile.

9. The method of claim 1, wherein the method is performed by one of a server, a computer, a personal computer, a portable computer, and a personal digital assistant.

10. A personal advertising server that selects advertisements and determines constraints for presenting the advertisements to a user on a mobile communication device, comprising:
a memory that stores at least a user profile database and an advertisement database; and
a personal advertising unit that receives context history information for a user from one or more retail companies, constructs a profile for the user using the received context history information, stores the user's profile in the user profile database, receives advertisements from the one or more retail company, stores the received advertisements in the advertisement database, selects stored advertisements to be sent to the user based on the user's profile, determines constraints on the selected advertisements based on at least one of location and time, and sends the selected advertisements and the determined constraints to the user's mobile communication device for presentation to the user at a particular location and a particular time based on the determined constraints.

11. The personal advertising server of claim 10, wherein the personal advertising unit communicates with mobile communication devices on an intermittent basis.

12. The personal advertising server of claim 10, wherein presentation of advertisements to the user on the user's mobile communication device is dependent on the user's schedule.

13. The a personal advertising server of claim 10, wherein the advertisements are one of pushed and pulled from the one or more retail companies.

14. The personal advertising server of claim 10, wherein the personal advertising unit receives current context information from the user's mobile communication device.

15. The personal advertising server of claim 14, wherein the user's current context information includes at least one of location, time, usability, temperature, luminosity, background noise, activity, schedule, physiology, ambient context, and other nearby devices.

16. The personal advertising server of claim 10, wherein advertisements are received from the retail companies based on at least one of a user's purchase habits, a user's shopping habits, a user's address, and a user's demographics.

17. The personal advertising server of claim 10, wherein the personal advertising unit receives the user's identification information, geographic position information, and time information relating to the user's geographic position information, from the user's mobile communication device, maps the received geographic position information to addresses of one or more retail companies, and stores the mapped addresses of the one or more retail companies and the related time information in the user's profile.

18. The personal advertising server of claim 10, wherein the personal advertising server is one of a server, a computer, a personal computer, a portable computer, and a personal digital assistant.

19. A method for presenting advertisements to a user on a mobile communication device, comprising:
transmitting a user's current context information to a personal advertising server, wherein the user's current context information may include at least one location, time, usability, temperature, luminosity, background noise, and other nearby devices;
receiving advertisements and constraints from the personal advertising server, the constraints on the advertisements being based on at least one of location and time; and
presenting the received advertisements to the user based on the received constraints.

20. The method of claim 19, wherein the mobile communication device is one of a portable MP3 player, a satellite radio receiver, an AM/FM radio receiver, a satellite television, a portable music player, a portable computer, a wireless radio, a wireless telephone, a portable digital video recorder, a cellular telephone, a mobile telephone, a personal digital assistant, and a combination of any of the above.
